(19) United States
(12) Patent Application Publication
(10) Pub. No.: US 2019/0158700 A1
(43) Pub. Date: May 23, 2019

(54) INFORMATION PROCESSING APPARATUS AND IMAGE FORMING APPARATUS

(71) Applicant: CANON KABUSHIKI KAISHA, Tokyo (JP)

(72) Inventor: Kosuke Yasaki, Toride-shi (JP)

(21) Appl. No.: 16/160,177

(22) Filed: Oct. 15, 2018

(30) Foreign Application Priority Data
Nov. 21, 2017 (JP) 2017-223896

(51) Int. Cl. H04N 1/409; G03G 15/00; H04N 1/00

(52) U.S. Cl. CPC H04N 1/409; G03G 15/5029; H04N 1/0075; H04N 1/00737; H04N 1/00745

(57) ABSTRACT

In an information processing apparatus connected with an image forming apparatus having an image forming unit, the image forming unit includes a first receiver, a light source, a photosensitive member, a rotatable polygon mirror including a plurality of reflection surfaces, a light receiver configured to receive light, an identifier configured to identify a reflection surface to be used for scanning the photosensitive member, and a first outputter. The information processing apparatus includes a second receiver configured to receive the predetermined signal, a corrector configured to correct the image data with correction data corresponding to the reflection surface corresponding to each scan line based on the specific reflection surface, and a second outputter configured to start outputting the image data in response to start of reception of the predetermined signal.

### BACKGROUND

### Field of the Disclosure

The present disclosure relates to an information processing apparatus configured to correct image data and transmit the image data to an image forming apparatus and further relates to the image forming apparatus with which the information processing apparatus is connected.

### Description of the Related Art

In the past, an electrophotographic image forming apparatus applying laser has been known wherein a laser beam deflected by a rotating polygon mirror scans an outer circumferential surface of a photosensitive drum to form a latent image on the outer circumferential surface of the photosensitive drum.

The polygon mirror configured to deflect such a laser beam may have surfaces having different shapes from each other. The surfaces having different shapes from each other may distort latent images on the outer circumferential surface of the photosensitive drum formed with a laser beam deflected by the surfaces.

Accordingly, U.S. Pat. No. 9,575,314 discloses a configuration in which an image controller identifies (surface identification) a surface of a polygon mirror which deflects a laser beam based on a time interval between pulses of adjacent inputted main-scanning synchronization signals. More specifically, the image controller performs processing for measuring a time interval between adjacent pulses to identify a surface corresponding to the pulses based on the measurement result. The image controller is configured to perform a correction corresponding to a surface on image data (or correction on a position for starting to write an image). Image formation may be performed based on the corrected image data. It should be noted that the surface identification is performed prior to formation of an image of a first page.

Japanese Patent Laid-Open No. 2000-313140 discloses a configuration in which an engine controller and a video controller exchange data via signal lines. Japanese Patent Laid-Open No. 2000-313140 further discloses reducing the number of signal lines for transmitting signals for determining a time to start image formation from the engine controller to the video controller Japanese Patent Laid-Open No. 2000-313140 further discloses a configuration which determines a time for starting image formation by using a signal line used for transmitting a main-scan synchronization signal from the engine controller to the video controller. More specifically, when an image formation for one surface (page) of a recording medium completes, output of a main-scan synchronization signal is stopped. After that, a restart of the output of a main-scan synchronization signal triggers to start an image formation to the photosensitive drum. In other words, a time for starting an image formation depends on a restart of an output of a main-scan synchronization signal.

Surface identification based on a time interval between adjacent pulses of the inputted main-scan synchronization signals as disclosed in U.S. Pat. No. 9,575,314 may require a time period for processing for measuring the time interval between the adjacent pulses and a time period for processing for identifying a surface corresponding to the respective pulses based on the measurement result.

A configuration which determines a time for starting an image formation only based on a main-scan synchronization signal as disclosed in Japanese Patent Laid-Open No. 2000-313140 may prevent the main-scan synchronization signal from being inputted to an image controller for each surface of a recording medium. Thus, when an image formation for one surface of a recording medium completes, the image controller cannot grasp a surface of a polygon mirror by which a laser beam is deflected. Therefore, in a case where the configuration disclosed in U.S. Pat. No. 9,575,314 is applied to the configuration disclosed in Japanese Patent Laid-Open No. 2000-313140, the image controller may be required to perform processing for measuring a time interval between adjacent pulses and identifying surfaces corresponding to respective pulses based on the measurement result every time input of a main-scan synchronization signal to the image controller is restarted. In other words, every time an image formation is performed on one surface of a recording medium, the image controller may be required to measure a time interval between adjacent pulses and identify the surfaces corresponding to the respective pulses based on the measurement result. This results in reduced productivity of the image forming apparatus.

### SUMMARY

In view of the above, aspects of the present disclosure can prevent reduction of productivity in an image formation for one surface of a recording medium.

An information processing apparatus connected with an image forming apparatus including an image forming unit includes a first receiver configured to receive image data, a light source configured to output light based on the image data received by the first receiver, a photosensitive member, a rotatable polygon mirror having a plurality of reflection surfaces and configured to rotate to deflect the light outputted from the light source by using the plurality of reflection surfaces and scan the photosensitive member, a light receiver configured to receive the light deflected by the rotatable polygon mirror, an identifier configured to identify a reflection surface to be used for the scanning of the photosensitive member of the plurality of reflection surfaces, a first outputter configured to output a predetermined signal in response to the receiving of the light by the light receiver while the light based on the image data inputted to the first receiver is being outputted from the light source, stop the predetermined signal after output of the image data for one surface of a recording medium completes, and restart the output of the predetermined signal at a time when image formation for one surface of a recording medium subsequent to image formation of the one surface of the recording medium is to be started. The first outputter outputs the predetermined signal based on a result of the identifying by the identifier such that the output is restarted from the predetermined signal based on the light deflected by a specific reflection surface of the plurality of reflection surfaces. The information processing apparatus further includes a second receiver configured to receive the predetermined signal output from the first outputter, a corrector configured to correct the image data corresponding to scan lines included in an image for the subsequent one surface of a recording medium with correction data corresponding to the reflection surface corresponding to the scan lines, based on that the predetermined signal first received by the second receiver after the output of the predetermined signal is restarted indicates the specific reflection surface, and a second outputter configured to start output of the image data for the subsequent one surface of a recording medium corrected by the corrector to the image forming unit in response to a start of reception of the predetermined signal from the first outputter.

Further features of various embodiments will become apparent from the following description of exemplary embodiments with reference to the attached drawings.

### BRIEF DESCRIPTION OF THE DRAWINGS

FIG. 1 is a cross-sectional view illustrating an embodiment of an image forming apparatus.

FIG. 2 illustrates an example of image data read by a reader.

FIG. 3 is a block diagram illustrating a configuration of an embodiment of a laser scanner unit.

FIGS. 4A and 4B illustrate examples of a relationship between BD signal generated by scanning a light receiving element in a BD sensor with a laser beam and a surface (surface number) on which the laser beam is deflected.

FIGS. 5A and 5B are time charts illustrating an embodiment of a relationship between signals and a count value.

FIG. 6 is a flowchart illustrating an embodiment of a control to be performed by an engine control unit.

FIG. 7 is a flowchart illustrating an embodiment of a control to be performed by an image control unit.

FIG. 8 is a time chart illustrating an embodiment of a relationship between signals and a count value.

FIGS. 9A and 9B are a flowchart illustrating an embodiment of a control to be performed by an engine control unit.

### DESCRIPTION OF THE EMBODIMENTS

With reference to drawings, embodiments of the present disclosure will be described below. However, shapes of components according to the embodiments and relative arrangements thereof should be changed in accordance with the conditions and the configuration of an apparatus to which the present disclosure is to be applied, and it is not intended that the scope of the present disclosure is limited to the following embodiments.

### First Embodiment

### Image Forming Operation

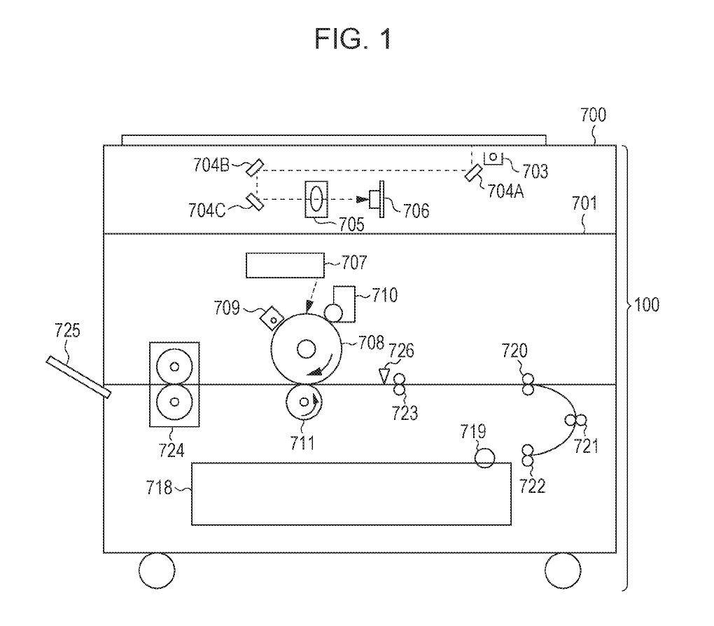

FIG. 1 is a cross-sectional view illustrating an embodiment of a configuration of an electrophotographic color copy machine (hereinafter, an image forming apparatus) 100. The image forming apparatus is not limited to a copy machine but may be a facsimile apparatus, a printing machine, a printer, or the like. Monochrome and polychrome image forming apparatuses are both applicable.

With reference to FIG. 1, a configuration and functions of the image forming apparatus 100 will be described below. Referring to FIG. 1, the image forming apparatus 100 has an image reading unit (hereinafter, a reader) 700 and an image printing apparatus 701.

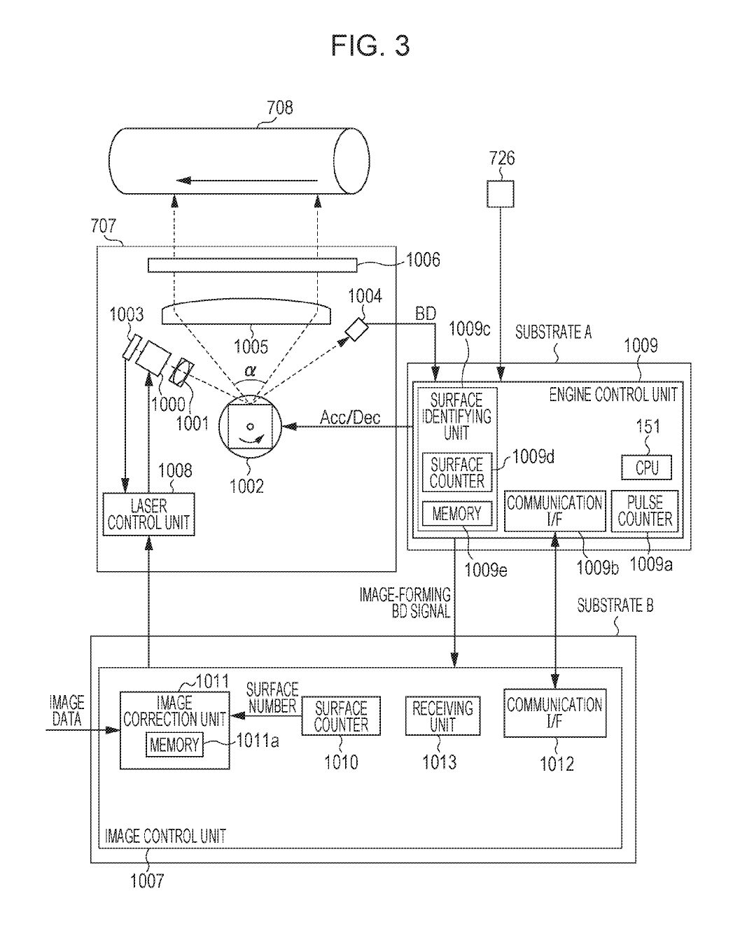

Reflected light from a document irradiated by an illumination lamp 703 at a reading position of the reader 700 is guided to a color sensor 706 through an optical system including reflection mirrors 704A, 704B, 704C and a lens 705. The reader 700 is configured to read light beams incident on the color sensor 706 color by color, such as blue (hereinafter, B), green (hereinafter, G), and red (hereinafter, R), and convert them to electrical image signals. The reader 700 is further configured to acquire image data by performing color conversion processing based on the intensities of B, G, and R image signals and output the image data to an image control unit 1007 (see FIG. 3), which will be described later.

The image printing apparatus 701 internally includes a sheet storage tray 718. Recording media stored in the sheet storage tray 718 are fed by a feed roller 719 and are sent out to an idle state registration roller 723 through conveyance rollers 722, 721, 720. A leading edge of a recording medium conveyed in a conveying direction by the conveyance roller 720 is abutted against a nip part of the idle-state registration roller 723. The recording medium with the leading edge abutted against the nip part of the idle-state registration roller 723 is further conveyed by the conveyance roller 720, bending the recording medium. As a result, an elastic force acts on the recording medium, and the leading edge of the recording medium is abutted along the nip part of the registration roller 723. In this manner, the skew correction is performed on a recording medium. After the skew correction is performed on the recording medium, the registration roller 723 starts conveying the recording medium at a time, which will be described below. The term “recording medium” refers to one on which an image is to be formed by an image forming apparatus and which may include paper, a resin sheet, cloth, an OHP sheet, and a label.

The image data acquired by the reader 700 are corrected by the image control unit 1007 and are inputted to a laser scanner unit 707 including a laser and a polygon mirror. The photosensitive drum 708 has an outer circumferential surface to be electrostatically charged by a charger 709. After the outer circumferential surface of the photosensitive drum 708 is electrostatically charged, based on image data inputted to the laser scanner unit 707 a laser beam is applied to from the laser scanner unit 707 to the outer circumferential surface of the photosensitive drum 708. As a result, an electrostatic latent image is formed on a photosensitive layer (photosensitive member) covering the outer circumferential surface of the photosensitive drum 708. A configuration in which an electrostatic latent image is formed on a photosensitive layer by a laser beam will be described below.

Next, the electrostatic latent image is developed with toner within a developer device 710, and the toner image is formed on the outer circumferential surface of the photosensitive drum 708. The toner image formed on the photosensitive drum 708 is transferred to the recording medium by a transfer charger 711 provided at a position (transfer position) facing the photosensitive drum 708. The registration roller 723 sends the recording medium to the transfer position in synchronization with the time when the toner image is transferred to a predetermined position on the recording medium.

In this manner, the recording medium having the transferred toner image thereon is sent to a fuser 724, and the fuser 724 performs heat pressing thereon to fix the toner image on the recording medium. The recording medium having a fixed toner image thereon is discharged to an external sheet discharge tray 725.

Thus, the corresponding image is formed on the recording medium by the image forming apparatus 100. Up to this point, a configuration and functions of the image forming apparatus 100 have been described.

### Configuration for Forming Electrostatic Latent Image

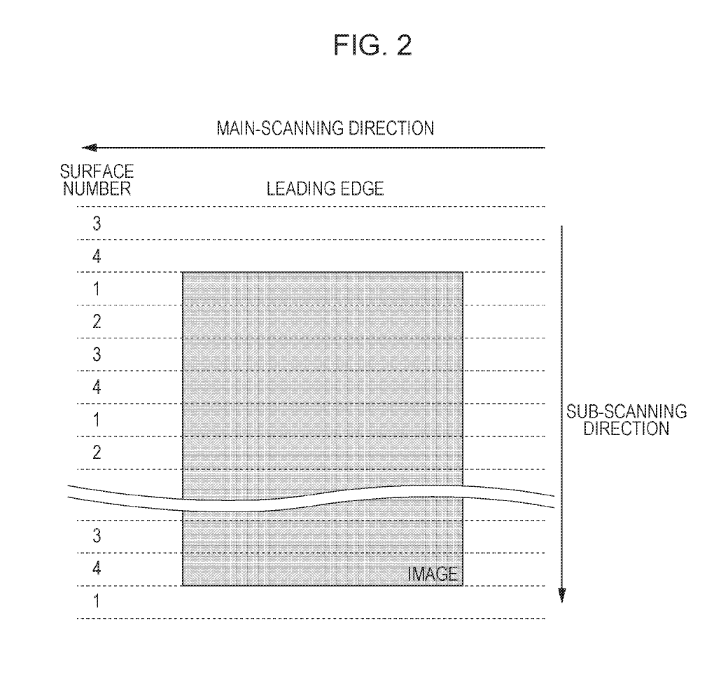

FIG. 2 illustrates an image equivalent to one surface of a recording medium. Surface numbers illustrated in FIG. 2 are numbers indicating reflection surfaces of the polygon mirror 1002, and the polygon mirror 1002 according to this embodiment has four reflection surfaces.

As illustrated in FIG. 2, a laser beam deflected by one reflection surface of a plurality of reflection surfaces of the polygon mirror 1002 scans the photosensitive layer in an axial direction (main-scanning direction) of the photosensitive drum 708 so that an image (electrostatic latent image) for one scan (one line) is filmed on the photosensitive layer. The electrostatic latent image for one surface of the recording medium is formed on the photosensitive layer through repeated scanning in the rotating direction (sub-scanning direction) of the photosensitive drum 708 of a laser beam deflected by the surfaces.

Data of an image corresponding to an electrostatic latent image for one line will be called image data hereinafter.

### Laser Scanner Unit

FIG. 3 is a block diagram illustrating a configuration of an embodiment of the laser scanner unit 707 according to this embodiment. A configuration of the laser scanner unit 707 will be described below. According to this embodiment, referring to FIG. 3, a substrate A having an engine control unit 1009 thereon is a different substrate from a substrate B having the image control unit 1007 thereon. The substrate A having the engine control unit 1009 thereon is joined (or connected) to the substrate B having the image control unit 1007 thereon via a cable.

As illustrated in FIG. 3, laser beams are emitted from both ends of a laser light source 1000. A laser beam emitted from one end of the laser light source 1000 enters to a photodiode 1003. The photodiode (PD) 1003 is configured to convert the incident laser beam to an electric signal and output it as a PD signal to a laser control unit 1008. The laser control unit 1008 is configured to perform a control (auto power control, hereinafter, APC) of an amount of outputted light from the laser light source 1000 such that the amount of outputted light of the laser light source 1000 can be equal to a predetermined amount of light based on the PD signal inputted thereto.

On the other hand, a laser beam emitted from the other end of the laser light source 1000 is applied to the polygon mirror 1002 as a rotatable polygon mirror through a collimator lens 1001.

The polygon mirror 1002 undergoes rotational drive by a polygon motor, which is not illustrated. The polygon motor is controlled with a drive signal (Acc/Dec) outputted from the engine control unit 1009.

The laser beam applied to the rotating polygon mirror 1002 is deflected by the polygon mirror 1002. The laser beam deflected by the polygon mirror 1002 scans the outer circumferential surface of the photosensitive drum 708 from right to left, or from left to right, in FIG. 3.

The laser beam for scanning the outer circumferential surface of the photosensitive drum 708 is corrected by an F-θ lens 1005 such that the laser beam can scan at a uniform speed the outer circumferential surface of the photosensitive drum 708 and is applied to the outer circumferential surface of the photosensitive drum 708 through the reflecting mirror 1006.

The laser beam deflected by the polygon mirror 1002 enters to a BD (Beam Detect) sensor 1004 as a light receiver including a light receiving element configured to receive the laser beam. According to this embodiment, during a period after the BD sensor 1004 detects a laser beam until the BD sensor 1004 detects the laser beam again, the BD sensor 1004 is placed at a position where the laser beam is applied to the outer circumferential surface of the photosensitive drum 708 after the laser beam is detected. More specifically, for example, the BD sensor 1004 may be placed in a region outside a region represented by angle a of a region through which the laser beam reflected by the polygon mirror 1002 passes and a region on an upstream side in a direction that the laser beam scans as illustrated in FIG. 3.

The BD sensor 1004 generates a BD signal based on the detected laser beam and. outputs it to the engine control unit 1009. The engine control unit 1009 controls the polygon motor such that the polygon mirror 1002 can have a predetermined rotation cycle based on the inputted BD signal. When the BD signal has a cycle corresponding to the predetermined cycle, the engine control unit 1009 determines that the rotation cycle of the polygon mirror 1002 has the predetermined cycle.

As illustrated in FIG. 3, the engine control unit 1009 receives a detection result from a sheet sensor 726 provided on a downstream side about the registration roller 723 in the direction for conveying a recording medium and configured to detect a leading edge of a recording medium.

When the sheet sensor 726 detects a leading edge of a recording medium, the engine control unit 1009 outputs a BD signal (image forming BD signal) to the image control unit 1007. The image forming BD signal is synchronized with the BD signal and corresponds to a signal indicative of one scanning cycle for scanning the photosensitive drum 708 by a laser beam. The engine control unit 1009 outputs the image forming BD signal in response to receipt of a laser beam by the BD sensor 1004.

In response to the image forming BD signal inputted to a receiving unit 1013 functioning as a receiver, the image control unit 1007 outputs the corrected image data to the laser control unit 1008. Specific control configurations of the engine control unit 1009 and the image control unit 1007 will be described below.

The laser control unit 1008 lights up the laser light source 1000 based on the inputted image data to generate a laser beam for forming an image on the outer circumferential surface of the photosensitive drum 708. In this manner, the laser control unit 1008 is controlled by the image control unit 1007 functioning as an information processing apparatus. The generated laser beam is applied to the outer circumferential surface of the photosensitive drum 708 in the manner as described above.

It should be noted that a distance L from a position where the sheet sensor 726 detects a recording medium to a transfer position is longer than a distance x in the direction of rotation of the photosensitive drum 708 from a position on the outer circumferential surface of the photosensitive drum 708 to which the laser beam is applied to the transfer position. More specifically, the distance L is a distance acquired by adding the distance x to a distance of conveyance of a recording medium during a period from a time when the sheet sensor 726 detects a leading edge of a recording medium to a time when the laser light source 1000 emits a laser beam. During a period from a time when the sheet sensor 726 detects a leading edge of a recording medium to a time when the laser light source 1000 emits a laser beam, correction on image data by the image control unit 1007 or a control over the laser control unit 1008 by the image control unit 1007 may be performed.

Up to this point the configuration of the laser scanner unit 707 has been described.

### Method for Identifying Surface of Polygon Mirror

The image control unit 1007 outputs corrected image data to the laser control unit 1008 in order from image data most upstream in the sub-scanning direction based on the cycle of the image forming BD signal inputted thereto. The laser control unit 1008 controls the laser light source 1000 based on the inputted image data to form an image on the outer circumferential surface of the photosensitive drum 708. Although the number of surfaces of the polygon mirror 1002 is equal to four according to this embodiment, the number of surfaces of the polygon mirror 1002 is not limited to four.

The image to be formed on a recording medium may be formed with a laser beam deflected by a plurality of reflection surfaces of the polygon mirror 1002. More specifically, for example, referring to FIG. 2, an image corresponding to the most upstream image data in the sub-scanning direction is formed with a laser beam deflected by a first surface of the polygon mirror 1002. An image corresponding to the second image data from the most upstream in the sub-scanning direction may be formed by a laser beam deflected by a second surface different from the first surface of the polygon mirror 1002. In this manner, an image to be formed on a recording medium may be an image to be formed with a laser beam reflected by different reflection surfaces of a plurality of reflection surfaces of the polygon mirror 1002.

In a case where a polygon mirror having four reflection surface is used as a polygon mirror for deflecting laser beams, there is a possibility that the angle formed by two adjacent reflection surfaces of the polygon mirror 1002 is not precisely 90°. More specifically, viewing the polygon mirror having four reflection surfaces in the direction of the rotational axis, there is a possibility that the angle formed by two adjacent borders is not precisely 90° (or the shape of the polygon mirror is not a square when viewed in the direction of the rotational axis). It should be noted that in a case where a polygon mirror is used which has n (where n is a positive integer) reflection surfaces, there is a possibility that the shape of the polygon mirror viewed from the direction of the rotational axis may not be a regular n-gon.

In a case where a polygon mirror having four reflection surfaces is used and when the angle formed by two adjacent reflection surfaces of the polygon mirror is not precisely 90°, the position and size of the image formed with a laser beam may vary in accordance with the reflection surfaces. As a result, the image formed on the outer circumferential surface of the photosensitive drum 708 may be distorted, and the image faulted on a recording medium may also be distorted.

According to this embodiment, image data are corrected (including correction of a write-out position) based on correction amounts (correction data) corresponding to each of reflection surfaces of the polygon mirror 1002. In this case, a configuration is to be provided for identifying a surface by which a laser beam is deflected. An example of a method for identifying a surface by which a laser beam is deflected will be described below. According to this embodiment, a surface identifying unit 1009c provided in the engine control unit 1009 is configured to identify a surface by which a laser beam is deflected (or reflected) of a plurality of reflection surfaces included in the polygon mirror 1002.

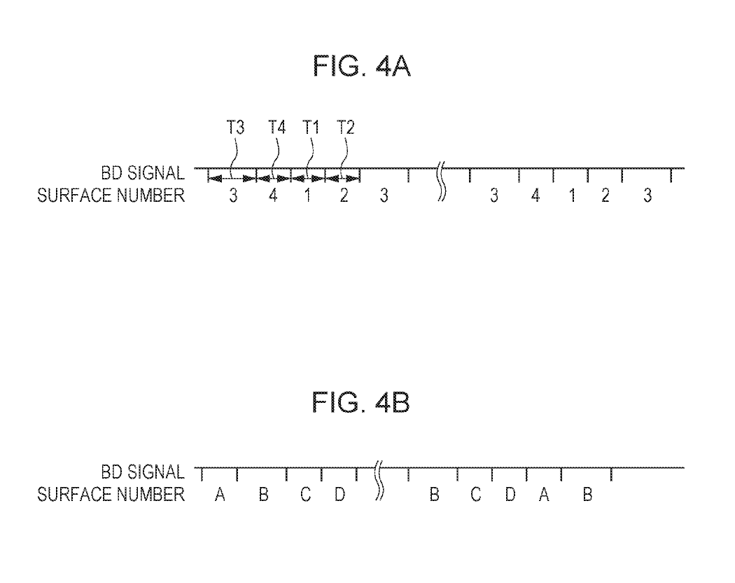

FIG. 4A illustrates an example of a relationship of a BD signal generated by scanning a laser beam on a light receiving surface of the BD sensor 1004 and a surface (surface number) by which the laser beam is deflected. As illustrated in FIG. 4A, the time period (scanning cycle) from a time when a pulse of a BD signal falls to a time when the BD signal first, after the pulse of the BD signal falls, rises varies in accordance with the surface of the polygon mirror 1002. The scanning cycle corresponds to a time period from a time when a laser beam scans a light receiving surface of the BD sensor 1004 to a time when the laser beam again scans the light receiving surface after the laser beam scanned the light receiving surface.

FIG. 4A illustrates a cycle T1 corresponding to Surface Number 1, a cycle T2 corresponding to a Surface Number 2, a cycle T3 corresponding to a Surface Number 3, and a cycle T4 corresponding to a Surface Number 4. These cycles are stored in a memory 1009e provided in the surface identifying unit 1009c.

The surface identifying unit 1009c is configured to identify a surface (surface number) by which a laser beam is deflected by the following method. More specifically, the surface identifying unit 1009c is configured to set surface numbers A to D against four continuous scanning cycles of a BD signal as illustrated in FIG. 4B. The surface identifying unit 1009c is then configured to measure scanning cycles for each of the surface numbers A to D multiple times (such as 32 times) and to calculate average values of the measured cycles for each of the surface numbers A to D.

The engine control unit 1009 identifies surface numbers 1 to 4 corresponding to the surface numbers A to D based on the calculated cycles and the cycles T1 to T4 stored in the memory 1009e.

In this manner, based on an inputted BD signal, the surface identifying unit 1009c can identify the number of a surface (reflection surface used for scanning the photosensitive drum 708 among a plurality of reflection surfaces of the polygon mirror 1002) by which a laser beam is deflected. Thus, the surface identifying unit 1009c can function as an identifying unit.

### Engine Control Unit

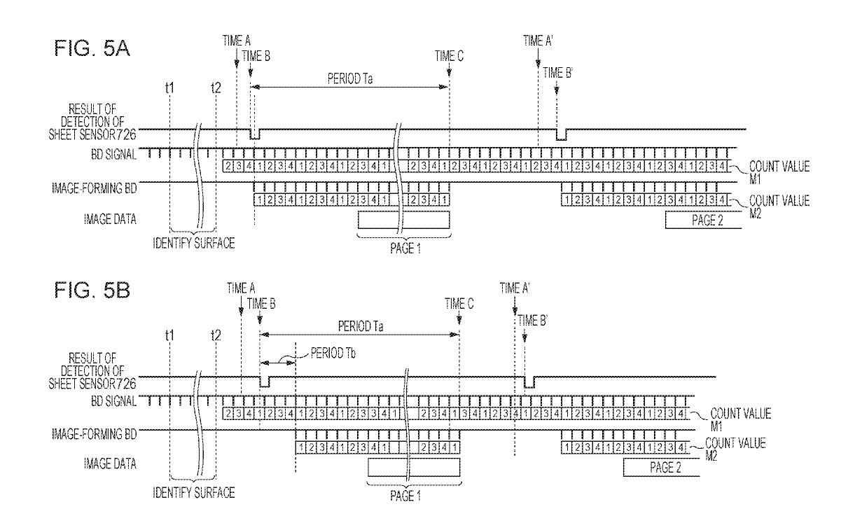

Next, controls to be performed by the engine control unit 1009 according to this embodiment will be described with reference to FIG. 3 and FIGS. 5A and 5B.

Referring to FIG. 3, the surface identifying unit 1009c has a surface counter 1009d configured to store surface information indicating a reflection surface by which a laser beam scanning a light receiving surface of the BD sensor 1004 is deflected from among a plurality of reflection surfaces.

FIGS. 5A and 5B are time charts illustrating relationships between signals and a count value M1 of the surface counter 1009d. FIG. 5A is a time chart illustrating a case where a first BD signal inputted to the engine control unit 1009 after the sheet sensor 726 detects a leading edge of a recording medium indicates a surface 1. FIG. 5B is a time chart illustrating a case where a first BD signal inputted to the engine control unit 1009 after the sheet sensor 726 detects a leading edge of a recording medium indicates a surface 2. The count value M1 of the surface counter 1009d corresponds to the surface information.

When the rotation cycle of the polygon mirror 1002 reaches a predetermined cycle (time t1), the engine control unit 1009 (or the surface identifying unit 1009c) identifies the surface number (determine the surface) by using the aforementioned method based on a BD signal inputted thereto.

The engine control unit 1009 starts counting by using the surface counter 1009d from a time t2 when the surface number unit 1009c completes the identification (estimation). More specifically, when the surface number identification is complete, the engine control unit 1009 sets the surface number corresponding to the first BD signal inputted after the surface number identification completes as an initial value of the count value M1 of the surface counter 1009d. The engine control unit 1009 sets an initial value of the count value M1 and then updates the count value M1 every time a rising edge of the inputted BD signal is detected. If the polygon mirror 1002 has n reflection surfaces (where n is a positive integer), M1 is a positive integer satisfying 1≤M1≤n.

After that, the CPU 151 controls the engine control unit 1009 to execute printing (or form an image on a recording medium) (at a time A). As a result, the engine control unit 1009 starts driving the registration roller 723. As a result, the sheet sensor 726 detects a leading edge of a first recording medium (at a time B). It should be noted that the time A is determined by the CPU 151 based on the processing time for a print job inputted to the image forming apparatus 100. In other words, the time A is not limited to times illustrated in FIGS. 5A and 5B.

The engine control unit 1009 outputs an image forming BD signal (image forming BD) such that the image forming BD signal corresponding to a specific surface number is first inputted to the image control unit 1007. More specifically, referring to FIGS. 5A and 5B, the engine control unit 1009 does not output an image forming BD signal during a period after the sheet sensor 726 detects a leading edge of a recording medium to a time when the BD signal is changed to a signal corresponding to the Surface Number 1. The engine control unit 1009 then starts outputting an image forming BD signal from a time when the BD signal first indicates the Surface Number 1 after the sheet sensor 726 detects a leading edge of the recording medium. It should be noted that the engine control unit 1009 outputs an image forming BD signal based on (or in synchronization with) a BD signal inputted from the BD sensor 1004. According to this embodiment, the fact that the detection result illustrated in FIGS. 5A and 5B is changed to have a low level corresponds to the fact that the sheet sensor 726 detects a leading edge of a recording medium.

The engine control unit 1009 notifies the image control unit 1007 through a communication OF 1009b of the number of pulses of the BD signal during a period Tb (refer to FIG. 5B) from the time B to a time when the engine control unit 1009 starts outputting the image forming BD signal. It should be noted that the number of pulses of the BD signal during the period Tb will be described below.

The engine control unit 1009 has a counter 1009a configured to count the number of pulses of an outputted image forming BD signal. The engine control unit 1009 stops outputting the image forming BD signal when the counted number of pulses reaches the number of pulses corresponding to one page (period Ta) of a recording medium. It should be noted that the number of pulses of the image forming BD signal during a period from a time when a pulse of the image forming BD signal is outputted to a time when output of image data is started may be lower than the number of pulses for identifying a surface.

After that, when the sheet sensor 726 detects a leading edge of a second recording medium conveyed subsequent to the first recording medium, the engine control unit 1009 starts outputting an image forming BD signal from a time when the BD signal first changes to a signal corresponding to the Surface Number 1 after the leading edge of the recording medium is detected.

According to this embodiment, the engine control unit 1009 starts outputting an image forming BD signal in response to the detection of a leading edge of a recording medium by the sheet sensor 726. However, embodiments of the present disclosure are not limited thereto. For example, the engine control unit 1009 may be configured to start outputting an image forming BD signal at a predetermined time after a recording medium is fed. The predetermined time may be set such that the position of a leading edge of a recording medium at the predetermined time can be an upstream side predetermined position about a transfer position.

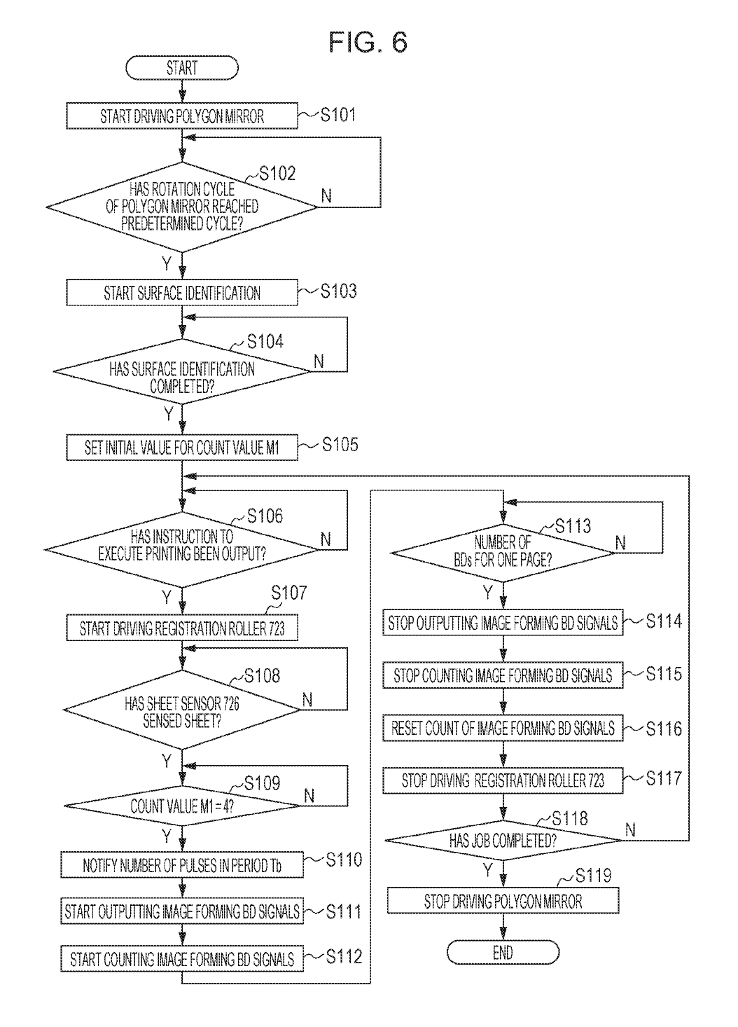

FIG. 6 is a flowchart illustrating an embodiment of a control to be performed by the engine control unit 1009. The processing in the flowchart illustrated in FIG. 6 may be executed by the engine control unit 1009. The following descriptions assume that the engine control unit 1009 updates the count value M1 every time the falling edge of an inputted BD signal is detected after the surface identification completes.

After a print job starts, the engine control unit 1009 in S101 starts driving a motor (polygon motor) to rotationally drive the polygon mirror 1002.

In S102, when the rotation cycle of the polygon mirror 1002 reaches a predetermined cycle, the engine control unit 1009 in S103 starts a surface identification (time t1).

After the engine control unit 1009 in S104 completes the surface identification (time t2), the processing moves to S105.

After that, the engine control unit 1009 in S105 sets the surface number corresponding to the BD signal inputted first after the surface number identification completes as an initial value for the count value M1 of the surface counter 1009d. When. an initial value is set, the engine control unit 1009 updates the count value M1 every time a falling edge of the inputted BD signal is detected.

Next, when an instruction to form an image on a recording medium is outputted from the CPU 151 in S106, the engine control unit 1009 in S107 starts driving the registration roller 723. As a result, the recording medium is started to convey.

After that, when a signal indicating that the sheet sensor 726 detects a leading edge of a recording medium is inputted to the engine control unit 1009 in S108, the processing moves to S109.

If the count value M1 of the surface counter 1009d reaches m (4, according to this embodiment) in S109, the engine control unit 1009 in S110 notifies the image control unit 1007 of the number of pulses of the BD signal during the period Tb through a communication I/F.

After that, in S111, the engine control unit 1009 starts outputting an image forming BD signal. As a result, the image forming BD signal corresponding to Surface Number 1 is first inputted to the image control unit 1007.

Then in S112, the engine control unit 1009 starts counting pulses of the outputted image forming BD signal. The engine control unit 1009 may be configured to count falling edges of pulses of an outputted image fainting BD signal, for example.

If the number of the counted pulses reaches the number of pulses corresponding to one recording medium (period Ta) in S113, the engine control unit 1009 in S114 stops outputting an image forming BD signal.

After that, the engine control unit 1009 in S115 completes the counting of pulses of the outputted image forming BD signal, and the engine control unit 1009 in S116 resets the count value.

The engine control unit 1009 in S117 further stops driving the registration roller 723.

Next, if the print job is not completed in S118, the processing returns to S106 again.

If the print job has been completed in S118, the engine control unit 1009 in S119 stops driving the polygon mirror 1002 and ends the processing of the flowchart.

Up to this point, the controls to be performed by the engine control unit 1009 have been described.

### Image Control Unit

Next, controls to be performed by the image control unit 1007 will be described. Referring to FIG. 3, the image control unit 1007 has a surface counter 1010 configured to store surface information indicating a reflection surface, among a plurality of reflection surfaces, by which a laser beam scanning a light receiving surface of the BD sensor 1004 is deflected. The image control unit 1007 further has a communication 1/F 1012 configured to receive information regarding the number of pulses received from the engine control unit 1009 during a period Tb. Functions of the surface counter 1010 and communication I/F 1012 will be described below.

When an image forming BD signal is inputted to the image control unit 1007, the image control unit 1007 sets 1 as an initial value of the count value M2 of the surface counter 1010. After setting e initial value of the count value M2, the image control unit 1007 may update the count value M2, every time a falling edge of an image forming BD signal inputted thereto is detected, for example. The count value M2 is outputted to an image correction unit 1011 as a surface number. In a case where the polygon mirror 1002 has n (where n is a positive integer) reflection surfaces, M2 is a positive integer satisfying 1≤M2≤n.

### Output Timing for Image Data

The image control unit 1007 is configured to determine a time for outputting corrected image data based on information regarding the number z of pulses (that is an integer satisfying 0≤z≤3) during a period Tb received from the engine control unit 1009 through the communication I/F 1012 and an image forming BD signal inputted from the engine control unit 1009 to the image control unit 1007. More specifically, the image control unit 1007 starts outputting corrected image data if y image forming BD signals are inputted after input of the image forming BD signals to the image control unit 1007 starts. Here, y can be expressed by the following Expression (1).

y=N−z (1)

Here, N is a number of pulses of image forming BD signals corresponding to a period from a time when the sheet sensor 726 detects a leading edge of a recording medium to a time when image data are outputted and is a preset value. According to this embodiment, N is set to 10, for example.

For example, in a case where the number z of pulses during a period Tb is equal to 0 as illustrated in FIG. 5A, the image control unit 1007 starts outputting corrected image data if 10 image forming BD signals are inputted (that is, from 11th pulse) after input of the image forming BD signals to the image control unit 1007 starts.

In a case where the number z of pulses during a period Tb is equal to 3 as illustrated in FIG. 5B, the image control unit 1007 starts outputting corrected image data if seven image forming BD signals are inputted (that is, from eighth pulse) after input of the image forming BD signals to the image control unit 1007 starts.

In this manner, according to this embodiment, if 10 pulses of the image forming BD signal are outputted from a time when the sheet sensor 726 detects a leading edge of a recording medium, output of corrected image data is started. As a result, the image is formed at a predetermined position of the recording medium.

### Correction of Image Data

The image correction unit 1011 functioning as a correction unit is configured to correct image data in order from image data A that is the most upstream image data in the sub-scanning direction of a plurality of data included in an image for one page illustrated in FIG. 2. More specifically, in a case where an image forming BD signal corresponding to Surface Number 1 is first inputted to the image control unit 1007, the image correction unit 1011 starts outputting image data when the image forming BD signal corresponding to the surface number changed (or updated) from the Surface Number 1 by y is outputted to the image control unit 1007. This is because output of corrected image data is started according to this embodiment when 10 pulses of image forming BD signals are outputted after the sheet sensor 726 detects a leading edge of a recording medium. A case where y is equal to 7 will be described below as an example according to this embodiment.

The image correction unit 1011 performs, on the image data A, a correction corresponding to Surface Number 4 changed from a Surface Number 1 seven times. More specifically, the image correction unit 1011 reads out correction data corresponding to Surface Number 4. The image correction unit 1011 then corrects the image data A based on the read-out correction data. After that, the image correction unit 1011 corrects the most upstream image data B of a plurality of image data on the downstream side about the image data A in the sub-scanning direction based on correction data corresponding to Surface Number 1 stored in the memory 1011a. The memory 1011a stores correction data. each corresponding to a surface number.

In this configuration, a laser beam based on image data corrected with correction data corresponding to Surface Number k (where k is an integer in a range from 1 to 4) is deflected by a reflection surface corresponding to the Surface Number k.

The image correction unit 1011 performs the aforementioned processing until a correction on image data for one surface of a recording medium has been completed.

The image correction unit 1011 outputs image data corrected region by region in the manner as described above to the laser control unit 1008 region by region in order from the upstream side (or from the image data A). It should be noted that the image correction unit 1011 outputs image data for one region to the laser control unit 1008 every time one pulse of an image forming BD signal is inputted (or based on the cycle of the image forming BD signal).

The image correction unit 1011 internally contains a counter (not illustrated) configured to count the number of regions of the outputted image data. When the counter has a count equivalent to one recording medium (or one page), output of image data is stopped.

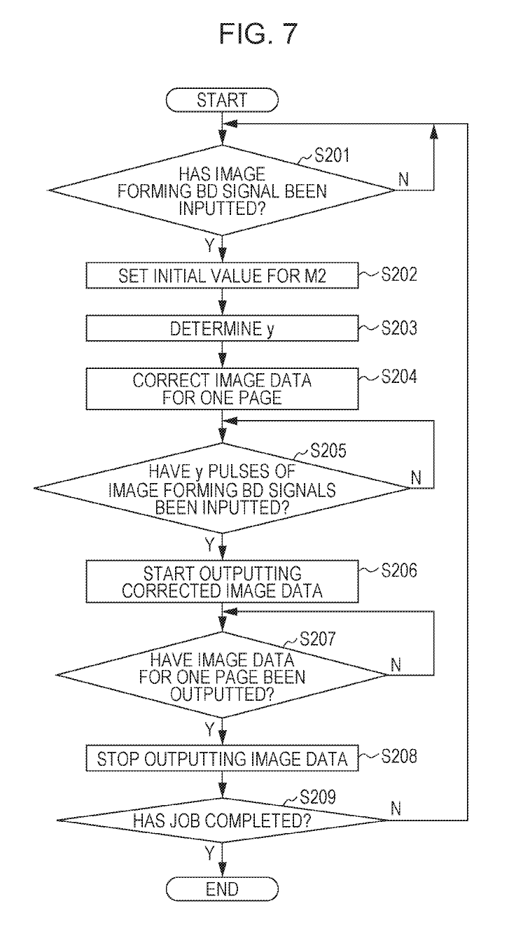

FIG. 7 is a flowchart illustrating an embodiment of a control to be performed by the image control unit 1007. It should be noted that, in this embodiment, the processing illustrated in the flowchart in FIG. 7 is to be executed by the image control unit 1007. The following descriptions assume that the surface number to be outputted from the surface counter 1010 to the image correction unit 1011 is updated every time the count value NI is updated. During a period when the flowchart illustrated in FIG. 7 is being executed, the image control unit 1007 (image correction unit 1011) counts the number of regions of outputted image data.

When an image forming BD signal is inputted to the image control unit 1007 in S201, the image control unit 1007 in S202 sets “1” as an initial value of the count value M2 of the surface counter 1010.

Next, in S203, a value y is determined based on the number z of pulses during the period Tb received through the communication I/F.

After that, in S204, the image control unit 1007 (image correction unit 1011) corrects, region by region, image data for one page of image data read by the reader 700 in the method based on y determined in S203.

When y pulses of image forming BD signals are inputted to the image control unit 1007 in S205 (or from (y+1)th pulse), the image control unit 1007 in S206 starts outputting corrected image data. The image control unit 1007 (image correction unit 1011) outputs the corrected image data region by region to the laser control unit 1008 based on a cycle of the image forming BD signals to be inputted.

After that, when the output of the image data for one page completes in S207, the image control unit 1007 in S208 stops outputting the corrected image data.

After that, the image control unit 1007 (image correction unit 1011) repeats the aforementioned processing until the print job ends.

According to this embodiment, the engine control unit 1009 stops outputting the image forming BD signals when image forming BD signals for one page are outputted. When the sheet sensor 726 detects a recording medium, outputting image forming BD signals are restarted. In other words, during a period from completion of rendering of the jth page (j=1, 2, 3 . . . ) to the start of rendering of the (j+1)th page, the engine control unit 1009 does not output image forming BD signals to the image control unit 1007. As a result, because image formation is started in response to an inputted image forming BD signal, the number of signal lines for transmitting signals for determining timing for starting image formation from the engine control unit 1009 to the image control unit 1007 can be reduced.

According to this embodiment, when a print job starts, the engine control unit 1009 performs the surface identification by the method described with reference to FIGS. 4A and 4B and FIGS. 5A and 5B. The engine control unit 1009 then outputs an image forming BD signal to the image control unit 1007 such that an image forming BD signal corresponding to a specific surface number (such as Surface Number 1) can be inputted to the image control unit 1007 first. As a result, when the image control unit 1007 restarts outputting an image forming BD signal to the image control unit 1007 (or every time image formation is performed on one surface of a recording medium), the image data can be corrected without performing the surface identification described with reference to FIGS. 4A and 4B and FIGS. 5A and 5B. This can prevent a reduction of the productivity of the image forming apparatus.

According to this embodiment, the engine control unit 1009 starts outputting an image forming BD signal from a time when the BD signal is inputted to the engine control unit 1009 where the BD signal first exhibits a surface number 1 after the seat sensor 726 detects a leading edge of a recording medium. However, some embodiments of the present disclosure are not limited thereto. For example, the engine control unit 1009 may start outputting an image forming BD signal from a time when the BD signal is inputted to the engine control unit 1009 where the BD signal first exhibits a surface number 1 after the seat sensor 726 detects a leading edge of a recording medium and the polygon mirror 1002 then rotates once.

### Second Embodiment

Like numbers refer to like parts in the configurations of the image forming apparatus according to the first and second embodiments, and any repetitive descriptions will be omitted.

### Engine Control Unit

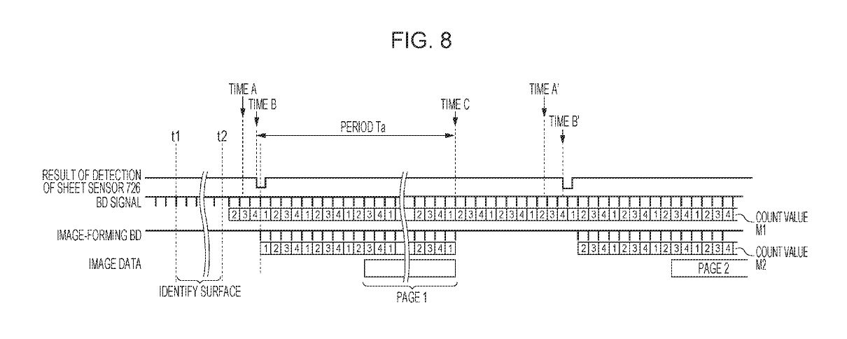

According to a first embodiment, the engine control unit 1009 outputs an image forming BD signal such that the image forming BD signal corresponding to a specific Surface Number 1 is first inputted to the image control unit 1007. According to this embodiment, as illustrated in FIG. 8, the engine control unit 1009 outputs an image forming BD signal such that the image forming BD signal corresponding to the number next to a surface number used last for forming an image on a jth page is inputted to the image control unit 1007 first when an image on the (j+1)th page is to be formed. Vlore specifically, in a case where Surface Number 1 is used last for the jth page, the engine control unit 1009 does not output an image forming BD signal until the BD signal becomes a signal corresponding to Surface Number 2 after the sheet sensor 726 detects a leading edge of a recording medium. In other words, the engine control unit 1009 starts outputting an image forming BD signal from a time when the BD signal first becomes a signal corresponding to Surface Number 2 after the sheet sensor 726 detects a leading edge of a recording medium. In a case where an image on the first page is to be formed, the engine control unit 1009 outputs an image forming BD signal such that the image forming BD signal corresponding to a specific surface number as 1 (one)) is inputted first to the image control unit 1007.

The engine control unit 1009 notifies the image control unit 1007 through the communication I/F 1009b of the number of pulses of BD signals during a period Tb from a time B to a time when the engine control unit 1009 starts outputting an image forming BD signal, like the first embodiment.

When the number of pulses counted by the counter 1009a reaches the number of pulses corresponding to one page of a recording medium (period Ta), the engine control unit 1009 stops outputting image forming BD signals. The number of pulses of image forming BD signals during a period from a time when a pulse of an image forming BD signal is outputted to a time when the output of the image data is started is lower than the number of pulses for identifying a surface.

The engine control unit 1009 has a memory 1009e configured to store a count value M1 of the surface counter 1009d when output of an image forming BD signal is stopped. When the output of an image forming BD signal stops, the engine control unit 1009 stores the count value M1 of the surface counter 1009d in the memory 1009e at the time when the output of the image forming BD signal stops.

After that, if the sheet sensor 726 detects a leading edge of a second recording medium conveyed subsequently to a first recording medium, the engine control unit 1009 starts outputting an image forming BD signal from a time when the count value M1 of the counter 1009d becomes a signal corresponding to the number subsequent to the count number stored in the memory 1009e. As a result, output of an image forming BD signal is started from a time when the BD signal becomes a signal corresponding to a number subsequent to the surface number last used for image formation onto the first recording medium.

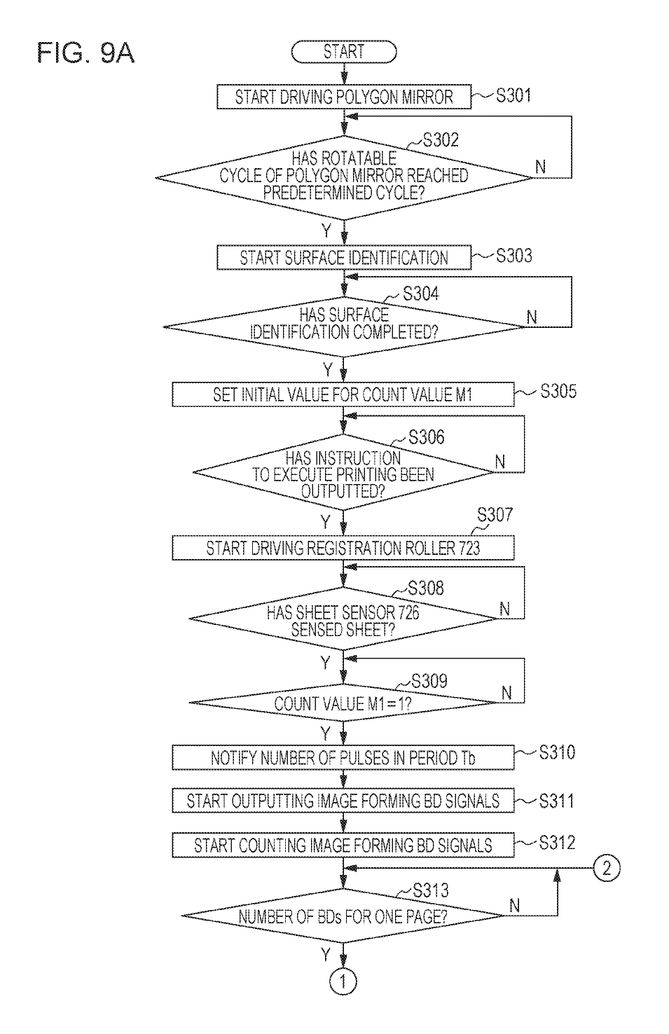

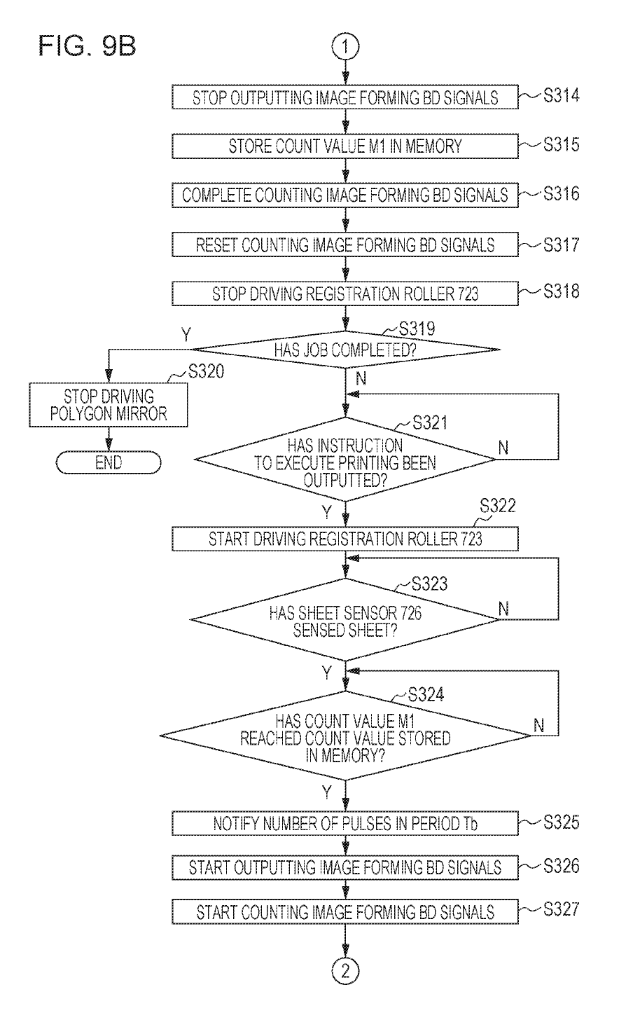

FIGS. 9A and 9B are flowcharts illustrating an embodiment of a control to be performed by the engine control unit 1009 according to this embodiment. The processing in the flowcharts illustrated in FIGS. 9A and 9B is executed by the engine control unit 1009. The following description assumes that the engine control unit 1009 updates the count value M1 every time a falling edge of an inputted BD signal is detected after the surface identification is completed.

Because the processing from S301 to S314 is the same as the processing from S101 to S114 in FIG. 6, any repetitive descriptions will be omitted.

In S315, the engine control unit 1009 stores the count value M1 of the surface counter 1009d in the memory 1009e when the output of image forming BD signals stops.

Because the processing from S316 to S318 after that is the same as the processing from S115 to S117 in FIG. 6, any repetitive descriptions will be omitted.

If the print job has not completed in S319, the processing moves to S321.

Because the processing from S321 to S323 is the same processing as the processing from S306 to S308, any repetitive description will be omitted.

If the count value M1 of the counter 1009d becomes a signal corresponding to the count value stored in the memory 1009e in S324, the processing moves to S325.

Because the processing from S325 to S327 is the same as the processing from S310 to S312, any repetitive descriptions will be omitted.

If the print job has completed in S319, the engine control unit 1009 in S320 stops driving the polygon mirror 1002, and the processing in the flowchart ends.

Up to this point, the control to be performed by the engine control unit 1009 has been described.

### Image Control Unit

Next, the image control unit 1007 will be described. Like the first embodiment, the image control unit 1007 sets 1 as an initial value of a count value M2 of the surface counter 1010 if an image forming BD signal is inputted to the image control unit 1007. After the initial value of the count value M2 is set, the image control unit 1007 may update the count value M2 every time a falling edge of an inputted image forming BD signal is detected, for example.

According to the first embodiment, output of an image forming BD signal corresponding to a specific surface number (such as 1 (one)) is controlled such that the image forming BD signal is inputted first to the image control unit 1007. For that reason, the image control unit 1007 sets a specific surface number as an initial value of the count value M2 for each page. In other words, every time image formation for one page is completed, the count value M2 is reset.

On the other hand, according to this embodiment, output of an image forming BD signal is controlled such that the image forming BD signal corresponding to a number subsequent to a surface number used last for the previous page is inputted first to the image control unit 1007. Therefore, the image control unit 1007 continues counting without resetting the count value M2 even when image formation for one page is completed (see FIG. 8). It should be noted that image data can be corrected in the same manner as that of the first embodiment based on the count value M2 and a number y of pulses.

According to this embodiment, as described above, the engine control unit 1009 stops outputting an image forming BD signal after the image forming BD signal for one page is outputted. Then, if the sheet sensor 726 detects a recording medium, the output of an image forming BD signal is started again. In other words, during a period from the completion of the rendering of the jth page to the start of rendering of the (j+1)th page, the engine control unit 1009 does not output an image forming BD signal to the image control unit 1007. As a result, because the rendering starts in response to an image forming BD signal inputted thereto, the signal line which is used for transmitting a signal for determining the timing of the start of the rendering from the engine control unit 1009 to the image control unit 1007 can be omitted.

According to this embodiment, if a print job starts, the engine control unit 1009 performs a surface identification in the manner described with reference to FIGS. 4A and 4B and FIGS. 5A and 5B. When the image on the (j+1)th page is formed, the engine control unit 1009 outputs an image forming BD signal such that the image forming BD signal corresponding to a number subsequent to a surface number used last for the jth page is inputted first to the image control unit 1007. As a result, when the image control unit 1007 restarts outputting an image forming BD signal to the image control unit 1007 (or every time image formation is performed on one surface of a recording medium), the image data can be corrected without performing the surface identification described with reference to FIGS. 4A and 4B and FIGS. 5A and 5B. This can prevent the reduction of productivity of the image forming apparatus.

Having described a monochrome electrophotographic copy machine according to the first embodiment and the second embodiment, the configurations of the first embodiment and second embodiment are also applicable to a polychrome electrophotographic copy machine.

According to the first embodiment and second embodiment, the engine control unit 1009 starts counting e number of pulses of output image forming BD signals when the output of the image forming BD signal starts. However, various embodiments are not limited thereto. For example, when the output of image data from the image control unit 1007 to the laser control unit 1008 starts, the engine control unit 1009 may be configured to start counting the number of pulses of outputted image forming BD signals.

According to the first embodiment and the second embodiment, the engine control unit 1009 stops the output of an image forming BD signal at a time C (see FIGS. 5A and 5B) when pulses for one recording medium are outputted. However, some embodiments of the present disclosure are not limited thereto. For example, the engine control unit 1009 may stop the output of an image forming BD signal at or after the time C and at a time before a time A′ when an instruction to execute printing of the next page is outputted. In other words, the engine control unit 1009 may stop the output of an image forming BD signal during a predetermined period from time C to the time A′. The time A′ corresponds to a time when image formation for one surface of a recording medium subsequent to one surface of a recording medium is started.

The laser light source 1000, the polygon mirror 1002, the photosensitive drain 708, the BD sensor 1004, and the engine control unit 1009 according to the first embodiment and the second embodiment may be included in an image forming unit.

According to the first embodiment and the second embodiment, the image control unit 1007 outputs corrected image data to the laser control unit 1008. However, some embodiments of the present disclosure are not limited thereto. For example, the image control unit 1007 may output corrected image data to the engine control unit 1009, and the engine control unit 1009 may output the image data to the laser control unit 1008. In other words, the image control unit 1007 may be configured to output corrected image data to the image forming unit.

According to the first embodiment and the second embodiment, the sheet sensor 726 is provided on an upstream side about a transfer position and on a downstream side about the registration roller 723. However, some embodiments of the present disclosure are not limited thereto. For example, the sheet sensor 726 may be provided on an upstream side about the registration roller 723, and the engine control unit 1009 may output an image forming BD signal in the manner described according to this embodiment based on the detection result provided by the sheet sensor 723.

According to the first embodiment and the second embodiment, a surface number is identified based on a cycle of BD signals as described with reference to FIGS. 4A and 4B and FIGS. 5A and 5B. However, the technique for identifying a surface number is not limited thereto. For example, a surface number can be identified based on a phase difference between a signal indicating a rotation cycle of a motor for performing rotational drive on the polygon mirror (such as an encoder signal or a FG signal) and a BD signal.

In view of the above, aspects of the present disclosure can prevent a reduction of the productivity of image formation for one surface of a recording medium.

While the present disclosure has described some exemplary embodiments, it is to be understood that the claims are not limited to the disclosed exemplary embodiments. The scope of the following claims is to be accorded the broadest interpretation so as to encompass all such modifications and equivalent structures and functions.

This application claims priority to Japanese Patent Application No. 2017-223896, which was filed on Nov. 21, 2017 and which is hereby incorporated by reference herein in its entirety.

What is claimed is:

1. An information processing apparatus connected with an image forming apparatus including an image forming unit, the image forming unit comprising:
a first receiver configured to receive image data;
a light source configured to output light based on the image data received by the first receiver;
a photosensitive member;
a rotatable polygon mirror having a plurality of reflection surfaces and configured to rotate to deflect the light outputted from the light source by using the plurality of reflection surfaces and scan the photosensitive member;
a light receiver configured to receive the light deflected by the rotatable polygon mirror;
an identifier configured to identify a reflection surface to be used for the scanning of the photosensitive member of the plurality of reflection surfaces;
a first outputter configured to output a predetermined signal in response to the receiving of the light by the light receiver while the light based on the image data inputted to the first receiver is being outputted from the light source, stop the predetermined signal after output of the image data for one surface of a recording medium completes, and restart the output of the predetermined signal at a time when image formation for one surface of a recording medium subsequent to image formation of the one surface of the recording medium is to be started, wherein the first outputter outputs the predetermined signal based on a result of the identifying by the identifier such that the output is restarted from the predetermined signal based on the light deflected by a specific reflection surface of the plurality of reflection surfaces, and
the information processing apparatus further comprising:
a second receiver configured to receive the predetermined signal output from the first outputter;
a corrector configured to correct the image data corresponding to scan lines included in an image for the subsequent one surface of a recording medium with correction data corresponding to the reflection surface corresponding to the scan lines, based on that the predetermined signal first received by the second receiver after the output of the predetermined signal is restarted indicates the specific reflection surface; and
a second outputter configured to start output of the image data for the subsequent one surface of a recording medium corrected by the corrector to the image forming unit in response to a start of reception of the predetermined signal from the first outputter.

2. The information processing apparatus according to claim 1, wherein the specific reflection surface is a predetermined reflection surface of a plurality of reflection surfaces included in the rotatable polygon mirror.

3. The information processing apparatus according to claim 1, wherein the specific reflection surface is a reflection surface adjacent to a reflection surface used for the last scan of a plurality of scans in an image formation for one surface of a recording medium and is a reflection surface on a downstream side of the reflection surface used for the last scan in a direction of rotation of the rotatable polygon mirror.

4. The information processing apparatus according to claim 1, wherein the second outputter starts to output the corrected image data to the image forming unit based on the number of times of receiving the light by the light receiver during a period from an output of a signal indicating an instruction of a start of output of the predetermined signal to the first outputter to a first output of the predetermined signal of a plurality of the predetermined signals corresponding to the image data for the one surface of a recording medium.

5. The information processing apparatus according to claim 1, wherein the corrector determines that the predetermined signal first received by the second receiver after output of the predetermined signal is restarted is a signal indicating the specific reflection surface and then updates surface information indicating the reflection surface every time the second receiver receives the predetermined signal.

6. The information processing apparatus according to claim 1,
the information processing apparatus further comprising:
a storage unit configured to store a plurality of correction data of the plurality of reflection surfaces in association with information indicating the plurality of reflection surfaces,
wherein
the corrector associates the correction data stored in the storage unit and a reflection surface configured to deflect the light scanning the photosensitive member based on the predetermined signal based on the light deflected by the specific reflection surface and corrects the image data with the correction data corresponding to a reflection surface deflecting the light scanning the photosensitive member,
the second outputter, when input of the predetermined signal to the second receiver is restarted, performs output to the image forming unit of image data corresponding to the light scanning the photosensitive member first of a plurality of the image data included in an image for the subsequent one surface of a recording medium and corrected by the correction unit in response to the predetermined signal.

7. The information processing apparatus according to claim 1, wherein the number of pulses of the predetermined signal during a period from a start of reception of the predetermined signal by the second receiver to a start of output of the image data for the one surface of a recording medium from the second outputter is lower than the number of pulses of the predetermined signals during a period for identifying the reflection surface by the identifier.

8. The information processing apparatus according to claim 1,
wherein a substrate including the second receiver is different from a substrate including the first outputter; and
the substrate including the second receiver is connected with the substrate including the first outputter via a cable.

9. The information processing apparatus according to claim 1, wherein the corrector corrects first image data by using first correction data corresponding to a reflection surface deflecting the light output from the light source based on the first image data, and corrects second image data different from the first image data by using second correction data corresponding to a reflection surface deflecting the light output from the light source based on the second image data.

10. An image forming apparatus including a generator which generates image data and an image forming unit which forms an image on a recording medium based on the image data outputted from the generator, the image forming comprising:
a first receiver configured to receive image data;
a light source configured to output light based on the image data received by the first receiver;
a photosensitive member;
a rotatable polygon mirror having a plurality of reflection surfaces and configured to rotate to deflect the light outputted from the light source by using the plurality of reflection surfaces and scan the photosensitive member;
a light receiver configured to receive the light deflected by the rotatable polygon mirror;
an identifier configured to identify a reflection surface to be used for the scanning of the photosensitive member of the plurality of reflection surfaces;
a first outputter configured to output a predetermined signal in response to the receiving of the light by the light receiver while the light based on the image data inputted to the first receiver is being outputted from the light source, stop the predetermined signal after output of the image data for one surface of a recording medium completes, and restart the output of the predetermined signal in response to a time when image formation for one surface of a recording medium subsequent to image formation of the one surface of the recording medium is to be started, wherein the first outputter outputs the predetermined signal based on a result of the identifying by the identifier such that the output is restarted from the predetermined signal based on the light deflected by a specific reflection surface of the plurality of reflection surfaces, and
the generator comprising:
a second receiver configured to receive the predetermined signal output from the first outputter;
a corrector configured to correct the image data corresponding to scan lines included in an image for the subsequent one surface of a recording medium with correction data corresponding to the reflection surface corresponding to the scan lines, based on that the predetermined signal first received by the second receiver after the output of the predetermined signal is restarted indicates the specific reflection surface; and
a second outputter configured to start outputting the image data for the subsequent one surface of a recording medium corrected by the corrector to the image forming unit in response to a start of reception of the predetermined signal from the first outputter.

11. The image forming apparatus according to claim 10, wherein the specific reflection surface is a predetermined reflection surface of a plurality of reflection surfaces included in the rotatable polygon mirror.

12. The image forming apparatus according to claim 10, wherein the specific reflection surface is a reflection surface adjacent to a reflection surface used for the last scan of a plurality of scans in an image formation for one surface of a recording medium and is a reflection surface on a downstream side of the reflection surface used for the last scan in a direction of rotation of the rotatable polygon mirror.

13. The image forming apparatus according to claim 10, wherein the image forming unit notifies the generator of the number of times that the light receiver receives light during a period from an output to the first outputter of a signal indicating an instruction of a start of an output of the predetermined signal to a first output of the predetermined signal of a plurality of the predetermined signals corresponding to the image data for the one surface of a recording medium, and
wherein the second outputter starts to output the corrected image data to the image forming unit based on the number of times of receiving the light by the light receiver notified by the image forming unit.

14. The image forming apparatus according to claim 10, wherein the corrector determines that the predetermined signal first received by the second receiver after output of the predetermined signal is restarted is a signal indicating the specific reflection surface and then updates surface information indicating the reflection surface every time the second receiver receives the predetermined signal.

15. The image forming apparatus according to claim 10,
the information processing apparatus further comprising:
a storage unit configured to store a plurality of correction data of the plurality of reflection surfaces in association with information indicating the plurality of reflection surfaces,
wherein
the corrector associates the correction data stored in the storage unit and a reflection surface configured to deflect the light scanning the photosensitive member based on the predetermined signal based on the light deflected by the specific reflection surface and corrects the image data with the correction data corresponding to a reflection surface deflecting the light scanning the photosensitive member,
the second outputter, when input of the predetermined signal to the second receiver is restarted, outputs, to the image forming unit, image data corresponding to the light first scanning the photosensitive member of a plurality of the image data included in an image for the subsequent one surface of a recording medium and corrected by the correction unit in response to the predetermined signal.

16. The image forming apparatus according to claim 10, wherein the number of pulses of the predetermined signal during a period from a start of a reception of the predetermined signal by the second receiver to a start of an output of the image data for the one surface of a recording medium from the second outputter is lower than the number of pulses of the predetermined signals during a period for identifying the reflection surface by the identifier.

17. The image forming apparatus according to claim 10,
the image forming apparatus further comprising:
a second storage unit configured to store information regarding a time interval corresponding to each of the reflection surfaces,
wherein the identifier determines the reflection surface based on a time interval for receiving the light by the light receiver and the information regarding the time interval stored in the second storage unit, during a period from a time when a print job is started to a time when the second outputter starts to output the image data for a first surface of the print job.

18. The image forming apparatus according to claim 10, wherein the first outputter stops outputting the predetermined signal after the first outputter outputs the number of the pulses corresponds to the image data for the one surface of a recording medium.

19. The image forming apparatus according to claim 10,
wherein the image forming apparatus has a sheet sensor provided on a conveyance path for conveying the recording medium and configured to detect a leading edge of the recording medium, and
wherein the first outputter starts to output the predetermined signal in a case where the sheet sensor detects a leading edge of the recording medium.

20. The image forming apparatus according to claim 10, wherein the corrector corrects first image data by using first correction data corresponding to a reflection surface deflecting the light outputted from the light source based on the first image data, and corrects second image data different from the first image data by using second correction data corresponding to a reflection surface deflecting the light outputted from the light source based on the second image data.
